(19) United States
(12) Patent Application Publication
(10) Pub. No.: US 2020/0146275 A1
(43) Pub. Date: May 14, 2020

(54) PEST MONITORING AND NOTIFICATION

(71) Applicant: Ecolab USA Inc., St. Paul, MN (US)

(72) Inventors: Joelle Francine Olson, Hanover, MN (US); Ryan J. Drake, White Bear Lake, MN (US); Andrew David Stewart, Inver Grove Heights, MN (US); Larry Arvid Lake, St. Paul, MN (US); Liliana Reategui, St. Anthony, MN (US); Danny Fue Vang, Brooklyn Park, MN (US); Alexander Roy Nee, Eagan, MN (US); Morgan Ann Manderfield, Inver Grove Heights, MN (US)

(21) Appl. No.: 16/678,627

(22) Filed: Nov. 8, 2019

Related U.S. Application Data
(60) Provisional application No. 62/758,016, filed on Nov. 9, 2018.

(51) Int. Cl. A01M 31/00; G08B 7/06; G08B 21/18; A01M 1/10; A01M 23/02

(52) U.S. Cl. CPC A01M 31/002; G08B 7/06; A01M 23/02; A01M 1/10; G08B 21/18

(57) ABSTRACT

A pest detection and notification system includes one or more pest monitors and notification badges or cards. Both the pest monitors and the notification badges are capable of short-range wireless communication. Upon detection of presence of a pest, a pest monitor generates and transmits a wireless pest event message. Any notification badge present within the transmission area of the pest monitor will receive the pest event message. Each notification badge includes one or more pest event indicators, such as an audible indicator, a visible indicator, and/or a vibration motor. Upon receipt of the pest event message, the notification badge activates one or more of the pest event indicators, thus notifying the wearer that a pest presence within the transmission area has been detected.

This application claims the benefit of U.S. Provisional Application No. 62/758,016, titled, “PEST MONITORING AND NOTIFICATION,” filed Nov. 9, 2018, the entire content of which is incorporated herein by reference.

### BACKGROUND

Detection and elimination of insects and other pests is important in many industries, including hospitality, foodservice, food and beverage processing, healthcare, retail and other environments. Presence of such pests, such as beg bugs, ants, cockroaches, small and large flies, rodents, etc., can result in negative guest impressions, present potential food safety risks, impact brand reputation, and result in significant loss of business. It is therefore desirable to detect insects and other pests at the earliest possible moment before an infestation becomes established.

However, insects and other pests may go long periods without being detected. Bed bugs, for example, are most active at night and primarily hide in tiny crevices or cracks during the day. Bed bugs may find easy hiding places in beds, bed frames, mattresses, box springs, furniture, along baseboards, in carpeting, and countless other places. Bed bugs can cling to possessions and hide in small spaces so that they may easily be transported in a traveler's belongings or luggage, and can go long periods of time without feeding. Bed bugs may also crawl from one nearby room to another. As a result, buildings where turnover of occupants is high, or where rooms are in close proximity to each other, such as hotels or apartments, are especially vulnerable to bed bug infestations. Ants, cockroaches, and other insects, not to mention rodents and other animal pests, can be similarly difficult to detect and eradicate.

Even when insects or other pests are found, control of the infestation can be difficult and disruptive to the business. Professional pest management professionals and/or pesticides are needed. In a hotel environment, for example, it may be necessary to remove all clutter and unnecessary objects from a room, remove insects and eggs as much as possible by vacuuming, and apply pesticides to likely hiding areas. This type of treatment for eradication can be disruptive to a business such as a hotel. In addition, even one publicized pest incident can be very harmful to a company's reputation, and may result in a significant loss of business.

### SUMMARY

The disclosure relates to systems, devices, and methods that monitor for and generate notifications concerning the presence of pests, such as insects, rodents, or other pest population(s).

In one example, the disclosure is directed to a pest detection and notification system comprising a plurality of pest monitors, each of the plurality of pest monitors including at least one pest detection sensor configured to detect presence of a pest within a pest harborage area and generate a corresponding pest presence signal; a controller configured to receive the pest presence signal and generate a pest event message, the pest event message including data indicating presence of a pest; and a wireless transceiver configured to wirelessly transmit the pest event message within a transmission area; and a plurality of notification badges, each notification badge including a wireless receiver configured to wirelessly receive pest event messages transmitted by any one of the plurality of pest monitors when the wireless receiver is located within the transmission area of the wireless transmitter of the any one of the plurality of pest event monitors; at least one pest event indicator; and a controller configured to receive the pest event message and activate the pest event indicator.

In some examples, the at least one pest event indicator may include at least one of an audible indicator, a visible indicator or a vibration motor. In some examples, the pest event message may further include data indicating a date and time that presence of an insect was detected, a pest monitor id, and/or data indicating a low battery condition of the pest monitor. In some examples, the controller of each of the plurality of pest monitors may be further configured to periodically generate a non-event message if no pest presence signal has been received, and wherein the wireless transceiver of each of the plurality of pest monitors is further configured to wirelessly transmit the non-event message within the transmission area. In some examples, the transmission area of the wireless transceiver is approximately 5 meters. In some examples, the pest harborage area may include a guest bed, and the transmission area of the wirelessly transmitter may be less than or equal to an area defined by the dimensions of the guest bed. In some examples, the pest harborage area may include a hotel room, and the transmission area of the pest monitor does not extend into an adjacent hotel room. In some examples, the insect detection sensor may include a capacitive sensing circuit. In some examples, the pest monitor may further include a pest trap that traps, retains or kills the pest. In some examples, the pest monitor may include at least one of a heat attractant, a chemical attractant, a lure, a bait, or a pheromone. In some examples, at least one of the plurality of pest monitors may further comprise a pest trap configured to detect and contain a pest, and the pest event message may include data indicating that the pest has been trapped.

In some examples, each pest monitor may further comprise a printed circuit board; a sensing electrode layer disposed on a top surface of the printed circuit board; and a textured layer disposed over at least a portion of the sensing electrode layer. The textured layer may include a mixture of a solder mask and a pumice material that is disposed over at least a portion of the sensing electrode layer. The textured layer may be coated, sprayed, or deposited over at least a portion of electrode layer. The textured layer may provide a rough surface texture for an insect pest to travel on.

In some examples, each pest monitor may further comprise a housing including a back surface and one or more sidewalls, the housing forming an interior pest retention chamber and having an opening in one of the sidewalls forming an entrance from outside the housing into the interior pest retention chamber, a floor of the entrance further including a ramp forming a path for a pest to travel from the entrance to the pest retention chamber, the ramp further forming a maximum angle of 30 degrees to the back surface of the housing. The ramp may form an angle of approximately 25 degrees to the back surface of the housing. The ramp may include a width that is relatively wider at the entrance as compared to a width of the pest retention chamber. The pest retention chamber may further include an electronically controllable trap door that closes when a pest is detected in the pest retention chamber. The ramp may further include a textured surface.

In another example, the disclosure is directed to a method comprising detecting, with a pest monitor, presence of a pest and generating a corresponding pest event message, the pest event message including data indicating presence of a pest; wirelessly transmitting the pest event message within a transmission range corresponding to a pest harborage area; and receiving, with a notification badge present within the transmission area, the pest event message; and activating at least one pest event indicator on the notification badge present within the transmission range upon receipt of the pest event message.

In some examples, activating the at least one pest event indicator may include activating at least one of an audible indicator, a visible indicator or a vibration motor. In some examples, the method may further comprise deactivating the at least one pest event indicator after a predetermined amount of time has elapsed. In some examples, the pest event message may further include at least one of a date and time that presence of an insect was detected, a serial number that uniquely identifies the pest monitor, or a low battery condition of the pest monitor. In some examples, the method may further comprise periodically transmitting a non-event message within the transmission range if no pest presence signal has been received. In some examples, the transmission range is approximately 5 meters from the pest monitor. In some examples, the method may further comprise trapping the pest with a pest trap, and wherein the pest event message includes data indicating that the pest has been trapped.

### BRIEF DESCRIPTION OF DRAWINGS

FIG. 1 illustrates an example environment in which the pest monitoring and notification techniques of the present disclosure may be used.

FIG. 2 illustrates an example notification badge in accordance with the present disclosure.

FIG. 3 is a block diagram of an example pest monitor module and an example badge module in accordance with the present disclosure.

FIG. 4 is a flow chart illustrating an example process by which a pest monitor controller may detect presence of a pest and wirelessly transmit a pest event message in accordance with the present disclosure.

FIG. 5 is a flowchart illustrating an example process by which a badge module controller may receive a pest event message and activate a pest presence notification in accordance with the present disclosure.

FIG. 6 illustrates a portion of an example pest monitoring and notification system including one or more pest monitor(s) and a plurality of notification badge(s).

FIG. 7A illustrates a perspective view of an example pest monitor having an electrode grid with the cover partially removed.

FIG. 7B illustrates a perspective view of the example monitor of FIG. 7A with the cover of the pest monitor in place.

FIG. 7C schematically illustrates a functional block diagram of the example pest monitor of FIG. 7A.

FIG. 8 is a block diagram illustrating an example computing system incorporating the pest monitoring and notification techniques of the present disclosure.

FIGS. 9A-9B illustrate another example pest monitor in accordance with the present disclosure.

FIGS. 10A-10F are diagrams illustrating various views of an example pest monitor in accordance with the present disclosure.

FIGS. 11A-11E are diagrams illustrating various views of the example pest monitor of FIGS. 10A-10F in accordance with the present disclosure mounted in a wall plate.

### DETAILED DESCRIPTION

The disclosure relates to devices, systems and methods that monitor for and generate notifications concerning the presence of insects or other pest population(s).

The system includes two types of devices, a pest monitor and a notification badge. Both the pest monitor and the notification badge are capable of short-range wireless communication. In the examples described herein, the short-range wireless communication may include distances of up to a few meters. Such relatively short transmission distances may be accomplished using any type of short-range communication techniques including short-range radio (RF) (e.g., Bluetooth, ZigBee, or ultra-wide band (UWB)) communication, infrared (IR) communication, or near field (NFC) communication techniques.

In some examples, the pest monitor may include both a pest monitoring/detection feature and a trapping feature. It shall therefore be understood that the term “pest monitor” as used throughout the present disclosure may include pest monitoring/detection and may also include a pest trap that captures (e.g., captures, retains, and/or kills) an insect, rodent or other animal pest, and that the disclosure is not limited in this respect.

A plurality of pest monitors are placed throughout a building or facility to monitor for the presence of insects or other pests. The pest monitors may be placed in or near pest harborage areas in which pests may be commonly found. In a hotel application, for example, one or more pest monitors may be placed within each hotel room or other defined area where detection of insect or other pest presence is desired. In the hotel example, the pest harborage areas may include an area around a guest bed in a guest room, an upholstered seating group in a lobby or restaurant, etc. In addition, each of a plurality of notification badges or cards are worn or carried by an associated one of a plurality of users. In a hotel application, for example, the users may include members of housekeeping staff, maintenance staff, front desk staff, hotel management, pest management professionals, etc.

In some examples, upon detection of an insect or other pest, a pest monitor generates and wirelessly transmits a pest event message including data indicating that a pest has been detected. In examples where the pest monitor includes a pest trap, the pest event message may further include data indicative that a pest has been trapped or that a pest trap has been triggered. The pest event message may be transmitted continuously or on a periodic basis. Any notification badge coming within the transmission area of the transmitting pest monitor will receive the pest event message. In some examples, each pest monitor is placed in or near a respective pest harborage area, and the transmission area of the pest monitor is set such that when a notification badge is sufficiently close to the respective pest harborage area to be within the transmission area of the pest monitor, the notification badge will receive the pest event message.

In other examples, a pest monitor may generate and wirelessly transmit a non-event message including data indicative of that no pest has been detected. Such a pest event message may be transmitted on a periodic basis for receipt by any notification badges within the transmission area. Such non-event messages may be useful for notifying a user that a pest monitor is actively monitoring for pests, but that no pests have been detected.

Each notification badge includes one or more pest event indicator(s). The pest event indicator(s) may include, for example, one or more audible indicator(s), one or more visual indicator(s), a vibration motor, and/or any other means for alerting or notifying the user that a pest event message has been received. Upon receipt of a pest event message, a notification badge may activate one or more of the pest event indicator(s) corresponding to detection of a pest, thus alerting the user that an insect or other pest has been detected within the transmission area in which the notification badge is located. Upon receipt of a non-event message, the notification badge may activate a different one of the pest event indicator(s) corresponding to non-detection, thus alerting the user that no insects or pests have been detected within the transmission area in which the notification badge is located. The non-detection indicator may also serve as feedback to a user that a pest monitor is connected to a power source or that any batteries associated with the pest monitor are adequately charged. If none of the badge indicator(s) are activated upon entry into a known transmission area, that may indicate that the pest monitor has been unplugged from a wall outlet, that the battery levels in the pest monitor may be low or in need of replacement, and/or that the pest monitor should be checked for some other malfunction.

Staff members may be trained to wear or carry the notification badges on a daily basis during work hours, and to notify a designated person(s), such as a supervisor, maintenance personnel, or pest management professional, in the event that a badge indicator indicative of a pest detection event is activated. The staff members may also be trained to notify the designated person(s) if no badge indicator(s) are activated, thus indicating a possible power issue or malfunction with one of the pest monitors. The staff member may communicate any of the following information upon activation of a badge indicator: a name of the staff member, a job title of the staff member, a badge identification number, a pest harborage area designation, a date, a time, a type of notification, a type of indicator activated, and/or any other relevant information.

In some examples, the wireless transmission/detection area of the pest monitor and the notification badge, and thus the distance over which the pest event message may be transmitted and received, is relatively short (up to 5 meters, for example). The distance may be chosen to correspond to pest harborage areas in which detection of insects or other pests may be desirable. In a hotel application, for example, the transmission area or range may be tailored to include a pest harborage area defined by the dimensions of a hotel room, an area around a hotel bed, an area around an upholstered seating grouping in a lobby, or other defined area. Pest harborage areas may also be defined for other industries including foodservice, food and beverage processing, healthcare, retail and other environments in which pest monitoring and detection may be desired.

Use of short-range communication between the pest monitor(s) and the notification badge(s) may help ensure that only notification badge(s) that physically enter a room or other defined pest harborage area will receive a pest event message from a pest monitor located in that particular area. In other words, physical entry of a notification badge into the relatively short transmission area or range of a pest monitor is required for the notification badge to receive a pest event message from that pest monitor.

In such examples, transmission of pest event messages for receipt by one or more notification badges present within range of the wireless transmission (that is, within a few meters of the pest monitor) as described herein, ensures that presence of pests is communicated to one or more users or staff members, who in turn are trained to notify a supervisor or other designated person. If each user wears or carries a notification badge or card capable of receiving wireless pest event messages from the pest monitor(s) placed throughout the environment to be monitored, the techniques of the present disclosure may help to ensure that each area is checked whenever a user enters the transmission area of a pest monitor. In a hotel application, for example, the techniques of the present disclosure may help to ensure that nearly every guest room is “checked” for presence of insects or other pests, at least when a room is turned over (i.e., upon guest check-out and subsequent entry of housekeeping staff to clean the room). In other words, periodic presence of one or more notification badges (as worn or carried by housekeeping staff, for example) means that the pest monitors in the guest rooms will have frequent opportunities to report insect or other pest presence to at least one notification badge.

In this way, early extermination efforts of insects and/or other pests may be undertaken. In many industries, even one reported encounter by a customer or member of the public with an insect or other pest leads to low levels of customer satisfaction, the possibility of a negative reputation in the community, and significant loss of business revenue. Early monitoring, detection, and notification of the presence of insects and other pests can help to reduce the possibilities of these negative effects. The pest monitors and notification badges as described herein thus provide a way for enterprises to proactively monitor for and detect presence of insects and other pests.

Another advantage of the pest monitoring and notification techniques described herein is that an enterprise need not rely on staff members to check or maintain pest traps, or inspect bed frames, bedding, draperies, furniture, etc., for signs of insects or other pests. At the same time, however, the system ensures that staff members are notified (via their notification badge) upon coming within range of a pest monitor if an insect or other pest has been detected. In this way, the system helps to provide early notifications concerning the presence of insects or other pests.

Although the present description uses hotels as an example environment in which the pest monitoring and notification techniques of the present disclosure may be used, it shall be understood that they may also be used in many other industries, environments and locations, and that the disclosure is not limited in this respect. For example, the pest monitors, notification badges, and/or pest monitoring and notification techniques described herein may also be used in schools; libraries; restaurants; food service or food processing facilities; healthcare facilities such as hospitals, clinics, and nursing homes; apartment buildings; vacation rentals; movie theaters; public transportation; shopping malls; waiting rooms; personal residences and homes; and any other location where detection of insects and/or other pests may be desired.

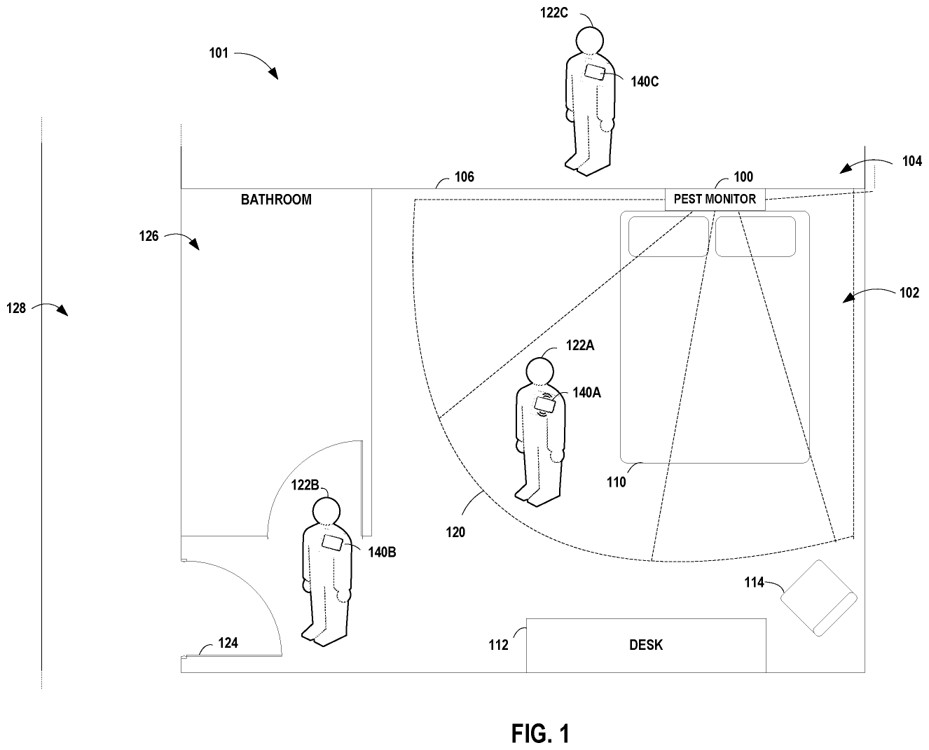

FIG. 1 illustrates an example environment 101 in which the pest monitoring and notification techniques of the present disclosure may be used. Example environment 101 of FIG. 1 is a hotel environment including a first guest room 102 and a second guest room 104. First and second guest rooms 102, 104 are separated by a wall 106. First guest room 102 includes a bathroom 126, a door area 124, and a guest bed 110. A hallway 128 is located outside of guest rooms 102 and 104. It shall be understood that environment 101 is for example purposes only, that the disclosure is not limited to hotel environments, that the pest monitoring and notification techniques may be used in and tailored to any other environment in which pest monitoring and/or detection is desired, and that the disclosure is not limited in this respect.

A pest monitor 100 in accordance with the present disclosure is located in first guest room 102. For purposes of this example, the guest bed 110 is determined to be a likely pest harborage area. In this example, pest monitor 100 has been placed near the headboard area of guest bed 110. It shall be understood that the example hotel environment and the example placement of the pest monitor in FIG. 1 are for descriptive purposes only and that the disclosure is not limited in these respects.

In general, pest monitor 100 includes electronic components configured to sense or detect presence of insects or other pests, and to generate and transmit a corresponding wireless pest event message including data indicative that a pest has been detected. In some examples, pest monitor 100 may also include a pest trap. In such cases, the pest event message may further include data indicative that a pest has been trapped or that the pest trap has been triggered. Pest monitor 100 may also periodically transmit non-event messages including data indicative that no pests have been detected.

In addition to the electronic components configured to sense or detect presence of insects or other pests, pest monitor 100 may include one or more mechanisms for attracting, baiting, capturing, retaining, and/or trapping aspects. Examples of various insect attractants, baits, capture, retaining, and trap configurations are described in U.S. Pat. No. 7,591,099 which is incorporated by reference herein in its entirety. For example, a pest monitor housing may include access openings between guide walls that are sufficiently large to allow an insect or other pest to pass through, and sufficiently close to make it likely that an insect or other pest will encounter a guide wall and follow it to the retention mechanism or into an area in which it is captured and/or retained. Alternatively, guide arms may extend from the pest monitor to increase the likelihood that insects or other pests will be directed toward the retention mechanism or into an area in which it is captured and/or retained.

Many different types of chemical attractants are known, including food-based attractants and pheromones. An attractant mechanism may be desirable for use in a pest monitor because it increases the likelihood that an insect or other pest will encounter and be detected by the monitor. This in turn increases the probability of early detection of a pest infestation. One example of an attractant is an aggregation or arrestant pheromone. A pheromone may be in gel form, in solid form, or impregnated into another materials. Examples of materials into which a pheromone may be impregnated may include cardboard, plastic, or an adhesive board. A pheromone may also be incorporated into an absorbent pad. Food type attractants may be used and may be in the form of liquid gel or in a solid form. For insects and other pests, food type attractants may simulate human odors. Olfactory attractants, such as components of human breath or perspiration, may also serve as an attractant mechanism in a pest monitor.

One or more tactile cues may also be used to attract insects and other pests. Bed bugs, for example, are attracted to materials with a rough surface texture and surface porosity, such as wood or cardboard, rather than on smooth plastic material. Examples of materials that may be incorporated into the pest monitor to attract insects or other pests may include wood, cardboard, corrugated cardboard, cotton, or wallpaper. Vibration, heat and humidity are other examples of tactile cues that may attract certain insects, and pest monitor 100 may therefore include heating devices, vibration devices/motors, and/or other electronic insect attractants.

For purposes of example and not by way of limitation, one or more pest monitor(s) 100 may be positioned in discreet location(s) in a room or other pest harborage area. For example, the pest monitor may be positioned in a location where it is not likely to be viewed by patrons of the establishment, such as positioned behind headboard (as shown in FIG. 1), under a bed, on a wall behind a fixture or piece of furniture, or other discreet location. A pressure sensitive adhesive may be used to secure the pest monitor to a discreet or hidden surface within the room. Alternatively, a screw, nail or tack may be used to affix the pest monitor to a surface. Another possible location for the pest monitor is under a box spring or under a mattress of the guest bed(s) 110. Pressure sensitive adhesive could be used to affix a pest monitor in this location.

It may be desirable to position the pest monitor(s) so that a torturous or difficult path to the pest monitor is required. With this type of positioning, a hotel guest would be least likely to view, handle, or move the monitor to a different location.

Many crawling insects prefer to walk along edges, and this behavior may be utilized to direct the insects toward the monitor. The pest monitor(s) may be positioned along an edge of a wall or headboard structure, or the monitor itself may incorporate guide walls. The pest monitor(s) can be positioned on a horizontal surface or a vertical surface or a surface that is neither horizontal nor vertical (e.g., on an incline). In addition, the housing of the pest monitor may include one or more textured surfaces positioned to guide or direct one or more pests toward a pest detection and/or retention area within the housing.

One or more pest monitor(s) 100 may be placed within each guest room 102 (or other pest harborage area). For example, in addition to the single pest monitor 100 located near headboard of guest bed 110, as shown in FIG. 1, another pest monitor 100 may be located near the desk/chair area, near a sofa or other soft furnishing grouping, near a dining table, etc. In rooms with two guest beds, another pest monitor may be located near or around a second guest bed 110.

One or more users, in this case staff members 122A-122C, each wear or carry an associated one of a plurality of notification badges or cards 140A-140C, respectively (referred to generally as notification badge(s) 140). Each of the plurality of notification badges 140 is capable of wireless communication with any of the plurality of pest monitors 100 deployed throughout the hotel, building, or other environment to be monitored.

In some examples, notification badges 140 are not necessarily uniquely associated with a particular user; that is, the notification badges do not store user identification information that uniquely identifies the user associated with the notification badge 140. In addition, the notification badges are not necessarily uniquely assigned to individual users by a supervisor and recorded in writing or electronically. In some examples, a user, upon starting their shift, wears, carries, or affixes a notification badge or card capable of receiving pest event messages on or to their person or workstation (such as a cleaning cart). As the badges are not uniquely assigned to individuals in this example, it does not matter which notification badge a staff member uses, as long as they have one on or near their person during their work shift to receive any pest event message(s) that may be transmitted in the areas in which they are working. In this way, a staff member may wear a different notification badge each day, or may keep the same badge for use on multiple days, and the disclosure is not limited in this respect.

The notification badges or cards 140 may take any of a number of different form factors. For example, notification badges 140 may include a chain, loop, or lanyard that is worn around the neck or wrist of a user. Notification badges 140 may include a clip, pin, magnet or holder to affix the notification badge to the clothing of a user. The notification badge or card 140 may further be sized to fit in the pocket of a user's clothing, or in a holder on a workstation, cart, or other implement or apparatus that the staff member takes around with them during the course of their shift.

As shown in FIG. 1, pest monitor 100 includes a pest event message transmission area or range indicated by dashed line 120. In this example, transmission area 120 includes the guest bed 110 and an area immediately surrounding guest bed 100 (e.g., about 1-2 meters around the perimeter of guest bed 100). In this example, transmission area 120 does not extend into bathroom 126 or beyond entry door 124. In some examples, the transmission range or area may be set or directional so that it does not extend into adjoining rooms, such as room 104, or into a hallway, such as hallway 128.

In some examples, guest room 102 may include two guest beds 110. In such examples, each guest bed may be associated with a different pest monitor 100, and each guest bed may therefore be associated with a different transmission area 120. In other words, each guest bed 100 may be associated with a different pest monitor 100, each of which provides a corresponding pest event transmission area around the respective guest bed 100. The pest event transmission areas 120 are tuned to minimize overlap between neighboring pest event transmission areas.

In other examples, transmission area 120 may include an area defined by the dimensions of the entire room, such as room 102. In other examples, transmission area 120 may include an area around desk 112 and chair 114, but not bathroom 126 or doorway 124. In other examples, a second pest monitor may be placed near desk 112 and/or chair 114 to provide a second pest event message transmission range or area around those items in the room. It shall be understood that multiple configurations for the transmission area 120 of a pest monitor 100 may be used, and that the disclosure is not limited in the number of pest monitors that may be placed in a room or defined area, or in whether the transmission area 120 covers all of a room or a portion of a room, or may extend outside a room in certain examples.

In other environments, the placement of the pest monitor(s) 100 within the environment may be determined by the location(s) of pest harborage areas (e.g., areas where insects or other pests are often found or where they may congregate or hide) within that environment.

Upon detection of a pest, pest monitor 100 generates and transmits a pest event message throughout the area defined by transmission area 120. Any notification badge 140 coming within transmission area 120 will receive the pest event message. In FIG. 1, for example, notification badge 140A, worn by user 122A, has entered into transmission area 120 and receives the pest event message being transmitted by pest monitor 100. Pest monitor 100 may further periodically generate and transmit non-event messages if no pests have been detected.

In some examples, pest monitor 100 may also transmit a longer-range pest event message for receipt by one or more local or remote computing devices that are outside the range of transmission area 120.

Each notification badge 140 includes one or more indicator(s). The pest event indicator(s) may include, for example, one or more of audible indicator(s), one or more visual indicator(s), a vibration motor, etc. Visual indicator(s) may be useful for notification badges 140 that are affixed to clothing or worn on the body of a user, and are therefore easily seen by a user when activated. Audible indicator(s) may be useful for those notification badges that are kept in a pocket or on a cleaning cart, or to help ensure that a user is notified of a pest event, non-event, low battery level, etc., even when the user is not viewing or within view of the notification badge 140. Vibration motors may be useful for those notification badges 140 that are kept in a pocket or otherwise out of view, to provide additional reinforcement of an audible or visual indicator, or for those environments where audible and/or visual indicators are not desired. The indicator(s) may be configured by the corporation or entity depending upon how the notification badge(s) are to be worn or carried by the staff members, and/or the desired level of viewability or audible reception (e.g., by guests of a hotel, patrons of a restaurant, patients in a hospital or clinic) of any pest event notifications. The indicator(s) may include one or more pest event indicator(s), one or more non-event indicator(s), one or more low battery indicator(s), or other status indicator(s) that may be useful or relevant to a pest monitoring system.

Upon receipt of a pest event message, a notification badge 140 will activate at least one pest event indicator to notify the user that a pest event message has been received. In FIG. 1, for example, notification badge 140A has activated one or more of a visual indicator, an audible indicator, a vibration motor, and/or other means of alerting a user that a pest event message has been received. Notification badges 140B and 140C, which are located outside of transmission area 120 of pest monitor 100, have not received the pest event message, and therefore have not activated their respective pest event indicators. Notification badge 140B, for example, is in the door area of room 102, and as notification badge 140B cannot receive the pest event message transmitted by pest monitor 100 when it is outside of transmission area 120, notification badge 140B has not received the pest event message and there has not activated its associated pest event indicator(s). Similarly, notification badge 140C, is in adjoining room 104, and as notification badge 140C cannot receive the pest event message transmitted by pest monitor 100 when it is outside of transmission area 120, notification badge 140C has not received the pest event message and there has not activated its associated pest event indicator(s). In general, any notification badge 140 that is outside transmission area 120 will not receive a pest event message from pest monitor 100, and will not activate any of its pest event indicators in response to that pest event message. Similarly, upon receipt of a non-event message, a notification badge 140 may activate at least one non-event indicator to notify the user that a non-event message has been received. The non-event message may be useful to inform or alert a user that the transmitting pest monitor is actively monitoring for pests, but that no pests have been detected.

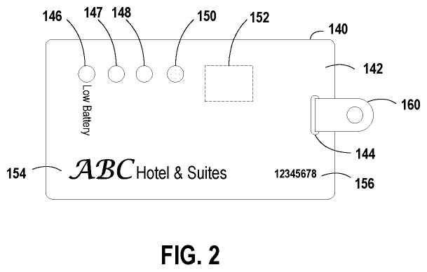

FIG. 2 illustrates an example notification badge or card 140 in accordance with the present disclosure. Notification badge 140 includes a substrate 142 having a slot 144 for receipt of a badge clip 160 to affix badge 140 to the clothing of a user. Alternatively, clip 160 may include a pin, magnet or other type of fastener or holder to affix the notification badge to the clothing of a user; a lanyard, bracelet or strap to wear around the neck or wrist of a user; a holder or other fastener to affix or hold badge 140 on a workstation, cleaning cart, or other implement or apparatus of a user, etc. Notification badge or card 140 may further be sized to fit in the pocket of a user's clothing, or in a holder on a workstation, cart, or other implement or apparatus that the staff member takes around with them during the course of their workday.

Notification badge 140 may further include an area on substrate 142 for a business name or company logo 154. Logo 154 may be customized to the location or business entity with which pest monitor system is being implemented. Notification badge may further include a unique badge identifier 156. Badge identifier may include one or more of a serial number, a barcode, a QR code, or other means of uniquely identifying a badge. The badge identifier may or may not be uniquely associated with a particular staff member, depending upon the specifications of the enterprise or business entity.

Notification badge further includes one or more indicators, which in this example include a low battery visible indicator 146, a non-event visible indicator 147, a pest event visible indicator 148, a pest event audible indicator 150, and a pest event vibration motor 152. It shall be understood that notification badge may include more or fewer or different types of indicators, and that the disclosure is not limited in this respect.

Visible indicators, such as visible indicators 146, 147 and 148, may include one or more light emitting diodes (LEDs) or other indicator that emits light when activated. Audible indicator 150 may include a speaker or buzzer that emits an audible sound when activated. Vibration motor 152 may include any motor that causes badge 140 to vibrate when activated. Alternatively, vibration motor 152 may include any other type of non-audible, non-visible indicator.

Low Battery visible indicator 146 may be activated (e.g., lighted) when a low battery condition associated with the badge's battery is detected. For example, circuitry within badge 140 may monitor the voltage level of the badge's internal battery (or batteries) and identify when the battery has reached a low battery condition or threshold. When the low battery condition has been detected, badge 140 may activate the low battery visible indicator 146, thus alerting the user that the internal battery should be replaced.

In some examples, pest monitor may be powered by from a standard 120 Volt AC outlet. In such examples, a backup battery may be provided so that pest monitoring and notification functions may still be provided even when the pest monitor is unplugged from the outlet. In such examples, notification badges 140 may also include an indicator that is activated when a pest monitor within range is not receiving 120 Volt AC power, so that the employee is alerted to check the pest monitor and plug it back into a standard 120 Volt AC outlet in the event that it has been unplugged.

Non-event indicator(s) 147 may be activated upon receipt of a non-event message has been received by notification badge 140. For example, upon entering the transmission range or area of a pest monitor that has not detected presence of pest, badge 140 may receive the corresponding non-event message. Upon receipt of the non-event message, badge 140 may activate non-event indicator 147 to alert the user that a non-event message has been received. The non-event message is indicative that the pest monitor is actively monitoring for pests, but that no pests are currently detected.

One or more of pest event indicator(s) 148, 150 and/or 152 may be activated when a pest event message has been received by notification badge 140. For example, upon entering the transmission range or area of a pest monitor that has detected presence of a pest (such as pest monitor 100 of FIG. 1) badge 140 may receive the corresponding transmitted pest event message. Upon receipt of the pest event message, badge 140 may activate one or more of visible indicator 148, audible indicator 150 and/or vibration motor 152 to alert the user that a pest event message has been received, and thus that a pest has been detected. The user may then follow proper training procedures for communicating the occurrence of the pest event, which may include verbal or written communication of the occurrence of the pest event to a designated person, such as a supervisor, maintenance personnel, or pest management professional.

In addition, indicators may further include a pest monitor low battery indicator that is activated when a low battery message is received from a pest monitor 100.

Each indicator may be a separate, dedicated indicator or one indicator may be assigned different colors (for example, red, green, or yellow) to indicate different status conditions (e.g., pest detected, low battery condition, device unplugged, etc.). In addition, one or more indicators may blink or remain constant. Thus, an indicator may blink red, blink green, or blink yellow, or remain constant in each available color. Further, the indicator(s) may blink at a faster and at a slower rate to provide further notification of different status conditions.

Notification badge 140 may further include a timeout feature by which any activated indicators 146, 147, 148, 150 and/or 152 are automatically turned-off or deactivated after a predetermined period of time. The period of time may be chosen to allow the user a reasonable time to notify the designated person(s) regarding the notification. Alternatively, or in addition, any reset of notification badge 140 may be accomplished by an authorized person, such as by wireless transmission of a reset message to a controller internal to badge 140, or by other authorized mechanism. This may help ensure that the alert indicators on notification badge 140 is/are not reset unless and until any pest event indications are properly communicated to the appropriate person(s).

In some examples, a location or business entity that wants to monitor for insects or other pests may employ a plurality of staff members or users who are each trained to wear or carry one of a plurality of notification badges 140 during the course of their workday or shift. In some examples, notification badges 140 are not necessarily uniquely associated with a particular user; that is, the notification badges do not store user identification information that uniquely identifies the user associated with the notification badge 140. In addition, the notification badges are not necessarily uniquely assigned to individual users by a supervisor and recorded in writing or electronically. In some examples, a user, upon starting their workday, wears, carries, or affixes a notification badge 140 capable of receiving pest event messages on or to their person or workstation (such as a cleaning cart). As the badges are not uniquely assigned to individuals in this example, it does not matter which notification badge a staff member uses, as long as they have one on or near their person during their work shift to receive any pest event message(s) that may be transmitted in the areas in which they are working. In this way, a staff member may wear a different notification badge each day, or may keep the same badge for use on multiple days, and the disclosure is not limited in this respect.

The staff members are further trained to communicate any pest event notifications (such as visible, audible, or vibration notifications activated on their badge 140) to a designated person, such as a supervisor, maintenance personnel, or pest management professional. In other words, upon activation of a pest event indicator on a notification badge, the staff member using that badge for the day is trained to communicate, in a defined way, the occurrence of the pest event notification. Information that may be communicated by the staff member to the designated person may include, for example, the date, the time, the staff member's name or employee number, the room number or area identification in which the pest event notification was received, and/or the type of pest event notification (e.g., audible, visible, vibration). In some examples, the staff members may further be trained, upon receipt of a pest event notification, to view or inspect the pest monitor(s) in the room or area and determine whether or not a pest event indicator on the pest monitor has been activated and/or whether a pest has been detected, captured, and/or retained by the pest monitor.

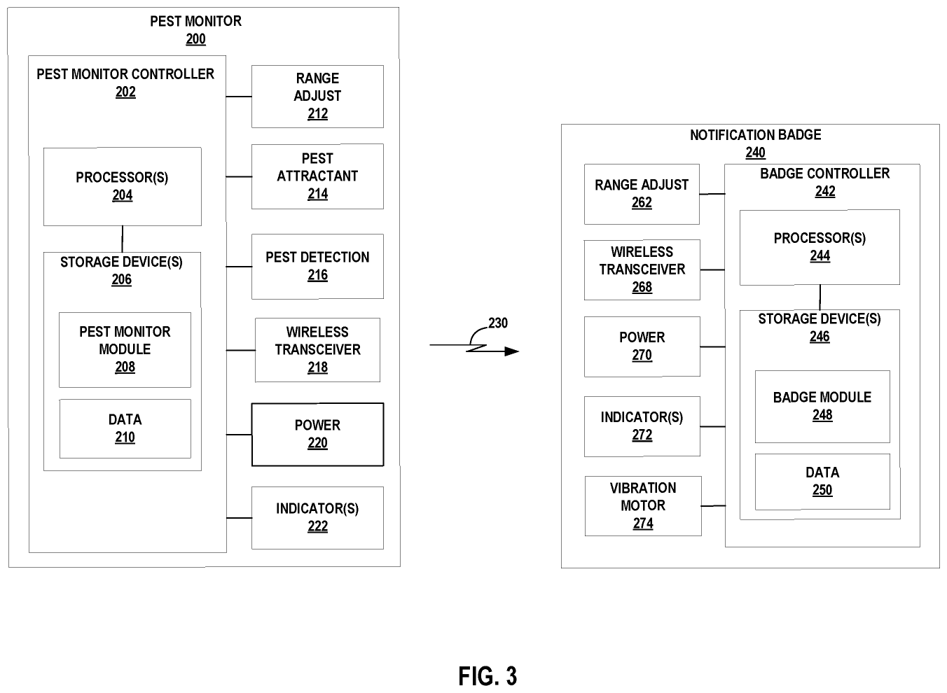

FIG. 3 is a block diagram showing example implementations of a pest monitor 200 and a notification badge 240 in accordance with the present disclosure. In this example, pest monitor 200 includes a controller 202 that includes one or more processor(s) 204 and storage device(s)/media 206. Processors 202, in one example, are configured to implement functionality and/or process instructions for execution within pest monitor 200. For example, processors 202 may be capable of processing instructions stored in storage devices 106. Examples of processors 202 may include, any one or more of a microprocessor, a controller, a digital signal processor (DSP), an application specific integrated circuit (ASIC), a field-programmable gate array (FPGA), or equivalent discrete or integrated logic circuitry, including other hardware processors.

Example pest monitor 200 further includes one or more wireless transceiver(s) 218, range adjustment buttons 212 to control the size and/or shape of the wireless transmission area, an electronically controlled insect attractant (such as a heat source) 214 a pest detection sensor 216, a power supply/regulator circuit 220, and one or more optional indicators 222.

Wireless transceiver(s) 218 of pest monitor module 200 is configured to wirelessly transmit pest event messages (as indicated by reference numeral 230) for receipt by one or more notification badge module(s) 240 upon detection of a pest by pest detection sensors 216. Wireless transceiver(s) 218 may also receive wireless communications from one or more notification badge(s) 240. Wireless transceiver(s) 218 may further be configured to receive updates to software, firmware, settings, etc., from an authorized computing device.

Storage device(s) 206 may be configured to store information and/or executable software instructions for pest monitor module 200. Storage devices 206, in some examples, can be described as a computer-readable storage medium. In some examples, storage devices 206 are a temporary memory, meaning that a primary purpose of storage devices 206 is not long-term storage. Storage devices 206, in some examples, may be described as a volatile memory, meaning that storage devices 206 do not maintain stored contents when the computer is turned off. Examples of volatile memories include random access memories (RAM), dynamic random access memories (DRAM), static random access memories (SRAM), and other forms of volatile memories known in the art. In some examples, storage devices 206 are used to store program instructions for execution by processors 302, such as pest monitor module application 208. Storage devices 206, in one example, may be used by software or application 208 running on controller 202 to permanently or temporarily store information used or generated during program execution.

Storage devices 206, in some examples, may also include one or more computer-readable storage media. Storage devices 206 may be configured to store larger amounts of information than volatile memory. Storage devices 206 may further be configured for long-term storage of information. In some examples, storage devices 206 may include non-volatile storage elements. Examples of such non-volatile storage elements include magnetic flash memories, or forms of electrically programmable memories (EPROM) or electrically erasable and programmable memories (EEPROM).

Storage device(s) 206 may store program instructions, such as pest monitor module application 208, for execution by processors 202. Pest monitor module application 208 includes instructions that, when executed by processors 202, allow controller 202 to implement the pest monitor module functionality, such as detect the presence of one or more insects or other pests, generate corresponding pest event messages, wirelessly transmit the pest event messages, non-event messages, low battery messages, etc., via wireless transceiver 218.

The pest event message may include, for example, an indication that an insect or other pest was detected. The pest event message may further include, for example, a pest monitor id and/or a time and date stamp for each detected pest event. The pest event message may further include, for example, a low battery indicator, a total number of pest events detected during a predetermined time interval, a date and time stamp corresponding to the date and time the individual pest event message was transmitted, a count of the number of notification badges to which the pest event message has been transmitted, and/or any other data relevant to the pest event.

Storage device(s) 206 may store various data (210) used or generated by processor(s) 204 during execution of the pest monitor module application instructions 208. For example, storage device(s) 206 may store pest event data, pest monitor identification information, battery level information, transmission range information, or other data associated with the pest monitor module 200.

Badge module 240 includes a badge module controller 242 that executes instructions stored on storage device(s) 246 to manage and control operation of a notification badge or card, such as any one of notification badge(s) 140 shown in FIG. 1. Badge controller 242 includes one or more processor(s) 244 and storage device(s) 246. A badge module application 248 stored in storage device(s) 246 includes instructions that when executed by processors 244, implement control of the functionality for the badge module 240. Storage devices 246 may further include data 250 that is used or generated during execution of badge module application 248.

Badge module further includes a range adjust circuit 262, a wireless transceiver 268, and a power module 270. Badge module 240 may further include one or more audible or visual indicator(s) 272 and/or a vibration motor 274.

Wireless transceiver 268 is configured to receive messages (both pest event messages and non-event messages) transmitted by the pest monitor modules 200 and transmit the messages to controller 242. Controller 242 may store the received messages in storage device(s) 246 as data 250. In some examples, controller 242 may attach a time and date stamp corresponding to the time and date the message was received. Wireless transceiver 268 may be further configured to receive updates to software, firmware, settings, etc., from an authorized computing device.

Power 220 may include one or more batteries and/or may include circuitry for receiving power from a standard 120 Volt AC power outlet. In some examples, the primary power for pest monitor 200 may include power from a standard 120 Volt AC power outlet with secondary or backup power being provided by one or more batteries in the event that pest monitor is unplugged. The batteries may be rechargeable, and may be recharged during times when the pest monitor 200 is connected to 120 Volt AC power. In addition, pest monitor 200 may include a low power or power saver mode when pest monitor 200 is being powered by batteries rather than a power source so as to extend battery life.

Upon receipt of a message from a pest monitor, controller 242 executes badge module 248 stored in storage device (246), and activates one or more of indicator(s) 272 and/or vibration motor 274. Indicators 272 may include one or audible indicators, such as any type of audible sound, alert, or alarm, including musical tones, human or simulated voice recordings, customized or personalized alerts, or any other means of audibly communicating a status notification. Indicators 272 may also include one or visual indicators, such as one or more LEDs.

Badge module 240 may determine which indicator(s) 272 and/or vibration motor 274 to activate depending upon the data received in the message. For example, if the message from the pest monitor is a pest event message including data indicative that a pest was detected, controller 242 may activate a visual indicator corresponding to and indicating detection of a pest. If the pest event message includes data that the voltage of batteries 220 on the pest monitor 200 are low, controller 242 may activate a different visual indicator corresponding to and indicating a low battery condition on the associated pest monitor. Similarly, if badge controller 242 determines that the voltage of batteries 270 on badge module 240 are low, controller 242 may activate a different visual indicator 272 corresponding to an indicating a low badge battery condition. As another example, if a predetermined amount of time has elapsed between the time that a pest was detected (as indicated in the pest event message) and the time it was received by a badge 240, controller 242 may cause the relevant pest detected indicator to flash rather than light at a steady state. If the message received from the pest monitor is a non-event message, controller 242 may activate a visual indicator corresponding to and indicating non-detection of a pest. It shall be understood that any combination of audible, visual, and/or vibration alerts may be generated for any of these different conditions, and that the disclosure is not limited in this respect.

In some examples, badge module 240 is implemented to provide a low power device capable of operating for extended periods (e.g., 3-6 months) on a low power voltage source 270, such as coin or button cell batteries or the like. The low power consumption may be achieved due to the low quiescent current requirements of the electronic components. Badge module 240 may also support low power consumption by utilizing a low power or sleep mode. Receipt of a pest event message wakes up the controller 242, which then executes the relevant instructions stored in badge module 248 to activate one or more of indicator(s) 272 or vibration motor 274. Badge module 240 may further help to achieve lower power expenditures and/or extended battery life by implementing a wireless receiver only in place of wireless transceiver 268.

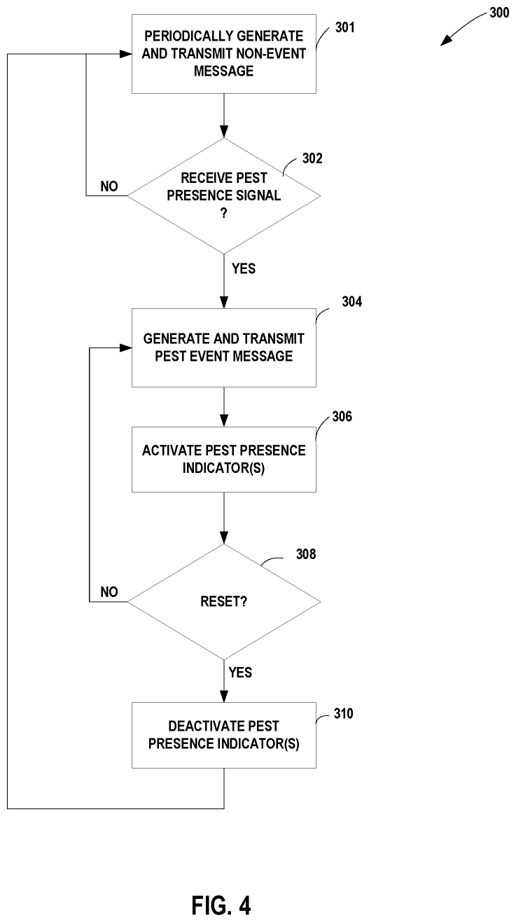

FIG. 4 is a flow chart illustrating an example process (300) by which a pest monitor module controller may monitor for presence of pests and generate and wirelessly transmit pest event message(s) and/or non-event message(s). Instructions for executing example process (300) may be stored in pest monitor module application 208 as shown in FIG. 3, as executed by processor(s) 204 of controller 202 to monitor for pest presence and transmit a pest event message(s) and/or non-event message(s).

Controller 202 periodically generates and transmits non-event message(s) as long as no pest presence signal is detected (301). The data included in the non-event message may include, for example, one or more of a date and time stamp, a pest monitor id uniquely identifying the transmitting pest monitor, a pest monitor battery status indicator, transmission range data for the pest monitor, and any other data that may be relevant to operation of the pest monitor and/or helpful to a pest management professional.

Upon receipt of a pest presence signal (302) from the pest detection sensors (such as pest detection sensors 216 as shown in FIG. 3), controller 202 generates and wirelessly transmits a pest event message (304). The data included in the pest event message may include, for example, one or more of data indicating that a pest was detected, a date and time stamp corresponding to the date and time the pest was detected, a pest monitor id uniquely identifying the transmitting pest monitor, a pest monitor battery status indicator, transmission range data for the pest monitor, and any other data that may be relevant to the pest detection event and/or helpful to a pest management professional.

If the pest monitor includes pest presence indicator(s) (see, e.g., indicators 222 in FIG. 3), controller 202 may activate one or more of the pest presence indicator(s) (306). This may provide an audible and/or visual alert on the pest monitor itself that a pest was detected. However, in some applications, such audible and/or visual indicators may not be desirable, in which case the pest monitor module controller generates and transmits the pest event message (304) for receipt by one or more notification badges and does not activate any indicators.

In some examples, the controller causes the wireless transceiver of the pest monitor module to transmit the pest event message either continuously or at periodic intervals (for example, once every 30 seconds or other appropriate time period) until a reset command is received (308). The reset may include depression of a switch on the pest monitor, receipt of an acknowledge (ACK) signal from a notification badge that the pest event message was received, a reset signal wirelessly received from a mobile computing device such as a smart phone or tablet computing device, or other means of instructing pest monitor to stop transmitting the pest event message.

In some examples, the pest monitor transmits the pest event message, either continuously or on a periodic basis, until confirmation of receipt of the pest event message by one or more notification badges and/or physical inspection of the pest monitor by an authorized person. This is to ensure that the pest event message was actually received and appropriate communication to the designated person(s), such as a supervisor, maintenance person, or pest management professional, were performed.

If a reset has not been received (308), the controller continues transmitting the pest event message (304) and optionally activating the pest presence indicators (306) until the reset is received (308). When the reset is received (308), the controller discontinues transmitting the pest event message and deactivates the pest presence indicators (310). Controller 202 may then continue periodically generating and transmitting non-event messages until another pest presence signal is received (301).

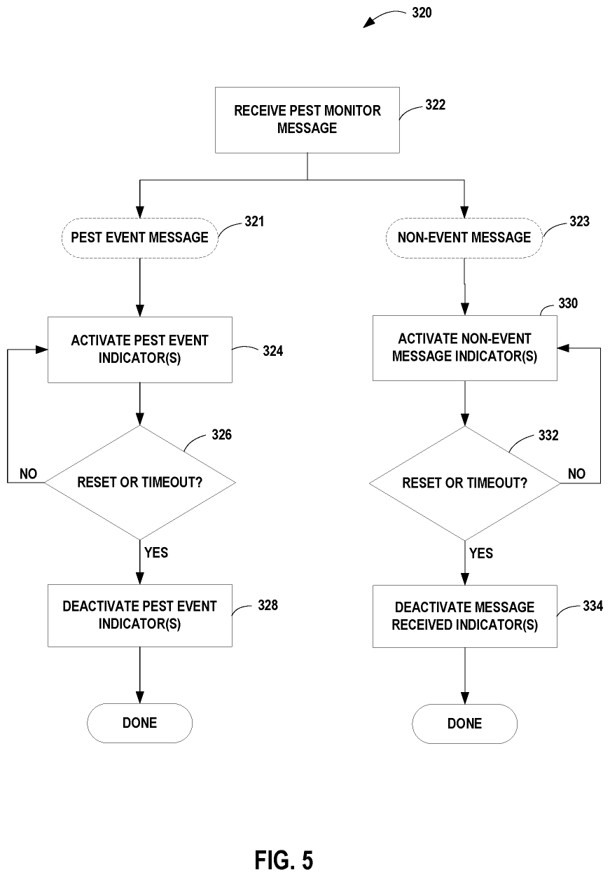

FIG. 5 is a flowchart illustrating an example process (320) by which a notification badge controller may receive a message from a pest monitor and activate one or more indicator(s) on the notification badge. Instructions for executing example process (320) may be stored in badge module application 248 as shown in FIG. 3. The instructions may be executed by processor(s) 244 of badge controller 242 to receive a message from a pest monitor and activate the one or more pest event indicator(s) or non-event indicator(s) on the badge.

A controller, such as notification badge controller 242 of FIG. 3, receives a message transmitted by a pest monitor, such as pest monitor 200 (322). As discussed above, the message may include a pest event message or a non-event message. The data included in a pest event message may include, for example, data indicating that a pest was detected, a date and time stamp corresponding to the date and time the pest was detected, a pest monitor id uniquely identifying the transmitting pest monitor, a pest monitor battery status indicator, transmission range data for the pest monitor, and/or any other data that may be relevant to the pest detection event and/or helpful to a pest management professional. The data included in a non-event message may include, for example, a date and time stamp, a pest monitor id uniquely identifying the transmitting pest monitor, a pest monitor battery status indicator, transmission range data for the pest monitor, and/or any other data that may be relevant to the pest detection event and/or helpful to a pest management professional.

Upon receipt of a pest event message (321), the controller activates one or more pest event indicators on the notification badge (324). For example, the controller may activate an LED indicator (or other type of visible indicator) on the notification badge to indicate that a pest was detected by a pest monitor in the room in which the notification badge is present. Alternatively, or in addition, the controller may activate an audible indicator on the notification badge, and/or activate a vibration motor on the notification badge, to indicate that a pest was detected. If the pest event message includes data indicative of a low battery condition on the pest monitor, the notification badge controller may activate a different one of the pest event indicators located on notification badge corresponding to a pest monitor low battery condition.

In some examples, the controller activates the pest event indicator(s) on a continuous or periodic basis (324) until the badge receives a reset command or until a predetermined amount of time has elapsed (326). In some examples, a reset of a notification badge may be performed by an authorized person, such as a supervisor or other designated person, to ensure that receipt of the pest event message is adequately communicated through the appropriate channels, thus helping to ensure that pest removal procedures are performed a quickly as possible after receipt of a pest event message. If a rest is not received and/or if the predetermined amount of time has not elapsed (326), the notification badge controller continues to activate the pest event indicators (324) on a continuous or periodic basis. When the operation has timed out (326), the controller deactivates the pest event indicators (328).

Upon receipt of a non-event message (323), the controller activates one or more non-event indicators on the notification badge (330). For example, the controller may activate an LED indicator (or other type of visible indicator) on the notification badge to indicate that no pests have been detected by a pest monitor in the room in which the notification badge is present. If the non-event message includes data indicative of a low battery condition on the pest monitor, the notification badge controller may activate a different one of the indicators located on notification badge corresponding to a pest monitor low battery condition.

In some examples, the controller activates the non-event indicator(s) on a continuous or periodic basis (330) until a rest is received or until a predetermined amount of time has elapsed (332). In some examples, a reset of a notification badge must be performed by an authorized person, such as a supervisor or other designated person, to ensure that receipt of the non-event message is adequately communicated through the appropriate channels. If a reset is not received and/or if the predetermined amount of time has not elapsed (332), the notification badge controller continues to activate the non-event indicators (330) on a continuous or periodic basis. When the operation has timed out (332), the controller deactivates the non-event indicators (334).

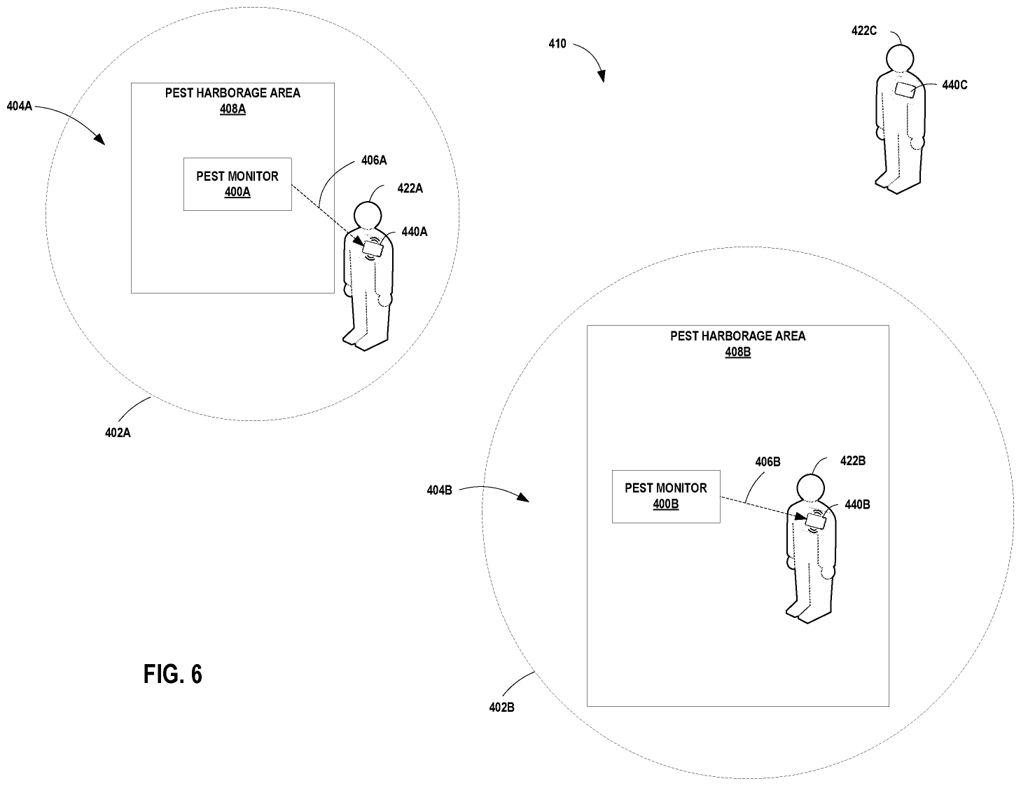

FIG. 6 illustrates a portion of an example pest notification system 410 including one or more pest monitor(s) 400A-400N and a plurality of notification badges 440A-440N, of which notification badges 440A, 440B and 440C are shown in FIG. 6. For purposes of illustration and not by way of limitation, FIG. 6 shows two pest monitors 400A-400B and three notification badges 440A-400C. It shall be understood that system 410 shown in FIG. 6 is for example purposes only, that the pest monitoring and notification techniques may be used in and tailored to any other environment in which pest monitoring and/or detection is desired, and that the disclosure is not limited in this respect. Pest monitors 400A-400N and notification badges 440A-440N may be implemented using, for example, pest monitor 100 and notification badge 140 as shown and described with respect to FIGS. 1-5.

In this example, pest monitors 400A and 400B are located in or near respective pest harborage areas 408A and 408B. Pest monitors 400A and 400B may include, for example, pest monitor 100 such as that shown and described above with respect to FIGS. 1 and 3-5.

In general, pest monitor(s) 400A-400N includes electronic components configured to sense or detect presence of insects or other pests, and to generate and transmit a corresponding wireless pest event message including data indicative that a pest has been detected. In some examples, pest monitor 400 may also include a pest capture, retention, and/or trapping mechanism. In such cases, the pest event message may further include data indicative that a pest has been captured, retained, and/or trapped or that a pest capture, retention or trapping mechanism has been triggered. Pest monitor 400 may also periodically transmit non-event messages including data indicative that no pests have been detected. Pest monitor 400 may include one or more mechanisms for attracting, baiting, capturing, retaining, and/or trapping aspects.

One or more users 422A-422C each wear or carry an associated one of a plurality of notification badges or cards 440A-440C, respectively (referred to generally as notification badge(s) 440). Each of the plurality of notification badges 440 is capable of wireless communication with any of the plurality of pest monitors 400 deployed throughout environment to be monitored.

Each pest monitor 400A-400N includes a corresponding pest event message transmission area 404A-404N or range indicated by dashed line 402A-402N. The size and shape of the transmission areas 404A-404N for each of the pest monitors 400A-400N may be determined at least in part by the size and shape of the corresponding pest harborage areas 408A-408N (e.g., areas where insects or other pests are often found or where they may congregate or hide).

Upon detection of a pest, a pest monitor 400 generates and transmits a pest event message throughout the area defined by the corresponding transmission area 404. Any notification badge 440 present in or moving into transmission area 404 will receive the pest event message. In FIG. 6, for example, notification badge 440A, worn by user 422A, is present in transmission area 404A of pest monitor 400A and receives the pest event message 406A transmitted by pest monitor 400. Similarly, notification badge 440B, worn by user 422B, is present in transmission area 404B of pest monitor 400B and receives the pest event message 406B transmitted by pest monitor 400B. Pest monitor(s) 400A-400N may further periodically generate and transmit non-event messages if no pests are currently detected, and these non-event messages may be similarly received by any of notification badges 440A-440N present within the respective transmission range 404A-404N.

Each notification badge 440A-440N includes one or more pest event indicator(s). The pest event indicator(s) may include, for example, one or more of audible indicator(s), visual indicator(s), a vibration motor, etc., as described herein. Upon receipt of a pest event message, a notification badge 440A-440N activates at least one pest event indicator to notify the user that a pest event message has been received. In FIG. 6, for example, notification badge 440A has activated one or more of a visual indicator, an audible indicator, a vibration motor, and/or other means of alerting user 422A that a pest event message (or a non-event message) has been received. Similarly, notification badge 440B has activated one or more of a visual indicator, an audible indicator, a vibration motor, and/or other means of alerting user 422B that a pest event message (or a non-event message) has been received. Notification badge 440C is not present within a transmission area 120 of a pest monitor 400A-400N, has not received messages from any of pest monitors 400A-400N, and therefore have not activated its respective pest event indicators. In general, any notification badge 440A-440N that is outside of transmission areas 404A-404N will not receive pest event messages or non-event messages from pest monitors 400A-400N, and will not activate any of its pest event indicators in response to that pest event message.

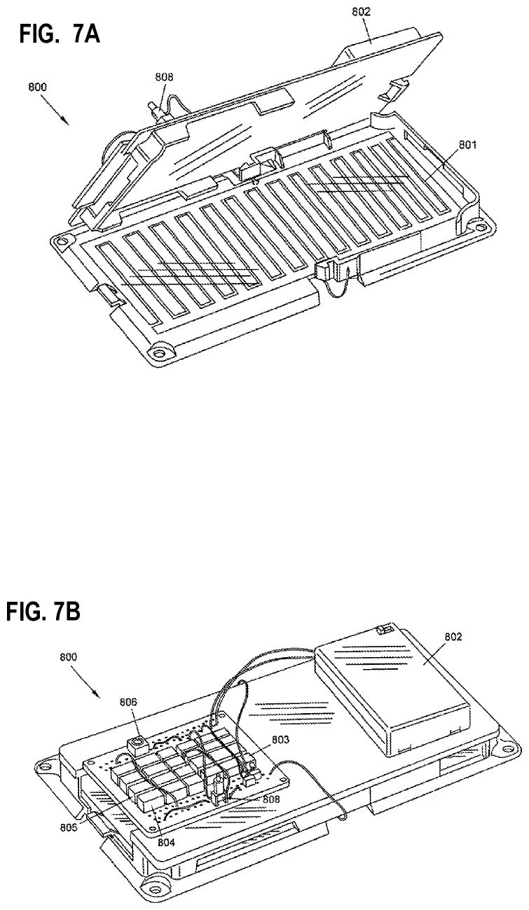

FIGS. 7A-7C illustrate a perspective view of an example pest monitor 800 having an electrode grid 801. Pest monitor 800, as well as other types of pest monitors, are described in U.S. Pat. No. 7,591,099, which is incorporated by reference herein in its entirety. Capacitive sensing circuit 803 is operatively attached to the electrode grid 801. Power module 802 is connected to the capacitive sensing circuit 803 and to a microprocessor or controller 804. A memory or storage device 805 is connected to controller 804 (and/or controller 804 may have its own on-board memory; not shown). Feedback switch 808 is connected to controller 804 and allows a user to provide feedback input, such as confirmation that pest monitor 800 has been physically checked or that the area in which the pest monitor 800 is located has been physically visited by a staff member or service technician. In this example, wireless communication of pest event messages is provided by a radio frequency (RF) transceiver device 807 and/or an infrared (IR) transceiver device 806. However, it shall be understood that monitor 800 may use any type of short-range or near field wireless communication to transmit pest event messages for receipt by one or more notification badges, and that the disclosure is not limited in this respect.

The pest detection portion of the pest monitor of FIG. 7C includes at least two sensor electrodes 801 and a capacitance sensing circuit 803. Capacitive sensing circuit 803 is arranged and configured to detect changes in the capacitive coupling between the electrodes of grid 801. As a non-capacitive object (e.g., a pest) approaches the sensor electrode grid 801, the capacitance of the sensor electrodes 801 increases due to the object having a higher dielectric constant than air. When a pest enters the area defined by electrode grid 803, the pest provides capacitive coupling between the electrodes of the grid 801, effectively decreasing the separation between the electrodes. Capacitance sensing circuit 803 detects the increased capacitance and provides an output signal that is received by controller 804 that a pest has entered the area being monitored.

When a threshold change in capacitance is detected, a pest presence signal is sent from the pest sensing electronics to controller 804. The time and date of the detected pest event may be determined by controller 804 and stored in memory 805. Controller 804 may then generate and wirelessly transmit a pest event message as described herein with respect to FIG. 4. The wireless message may be transmitted via RF transmitter 807, IR transmitter 806, or by other means of wireless transmission.

In some examples, if the pest event data is stored in storage device 805, it may be transmitted at a later time (e.g., in a batch mode) via RF device 807. The pest event data may also be stored for transmission after additional data is entered at manual input device (switch) 808. If RF device 807 provides for two-way transmission, the pest event message can also be transmitted upon request of a user computing device, such as a mobile computing device (e.g., smart phone, tablet computing device, laptop computing device, etc.).

In some examples, pest monitor 800 does not need to immobilize or trap a pest to communicate detection of a pest (i.e., a pest event message) to a user card or badge. This benefit allows pest monitor 800 to transmit alerts regarding pest activity without causing employees or inspectors to view unsightly pests.

Trap 809 is an optional pest retaining/capturing mechanism that may be used in connection with pest monitor 800. Trap 809 may include a glue board, adhesive layers, an electrocution grid, a passive trap, an enclosure, etc. Trap 809 may include a sensor to sense if a pest has been trapped/captured, and may send a corresponding trapped pest signal to controller 804. The trapped pest signal may indicate, for example, that the trap should be checked for trapped pests. Trap 809 may also include a visible or audible indicator integral to the trap that is actuated upon sensing that a pest has been trapped/captured/retained by the pest trap. Trap 809 may further include one or more of cardboard, fluted cardboard layers, crevices, wood, one or more attractants (e.g., heat, chemical, and/or vibration attractants), or a bait. A trap enclosure may further include one or more of textured walls, serrated walls, canted surfaces, a cover, etc.

The various styles of traps 809 may include a large variety of commercially available traps for trapping any type of insects, rodents or other animal pests. Examples of commercially available live insect/animal/rodent traps are the DeltaFive; Verifi; BB alert; Climbup; Blackout; SenciTrap; Victor M310 Tin Cat; the Havahart Live Traps; the Kwik Katch Mouse Trap, and the Kness Ketch-All. Examples of commercially available zapping light traps are the Gardner AG2001; the Gardner AG-661 Light Trap, and the Anderson Adhesive Insect Light Trap. Examples of commercially available glueboard light traps are the Ecolab Stealth Unit; the Gardner WS25; the Gardner GT100, and the Anderson Adhesive Insect Light Traps. It shall be understood, however, that any of the pest monitoring and notification devices described herein need not include a mechanism for capturing, retaining or trapping pests, and that the disclosure is not limited in this respect.

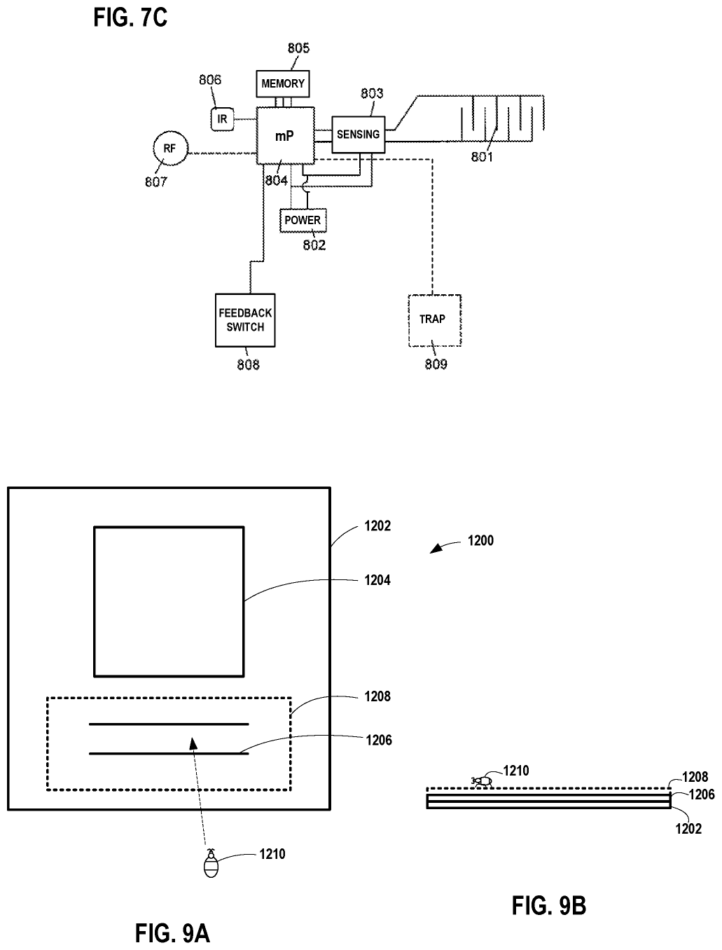

FIG. 8 is a block diagram illustrating an example computing system 1000 incorporating the pest monitoring and notification techniques of the present disclosure. FIG. 8 shows a plurality of establishments 1002A-1002N that are to be monitored for presence of pests. A plurality of pest monitor(s) 1004, a plurality of notification badges 1006 are associated with each establishment 1002A-1002N, and one or more local computing device(s) 1008. Computing system 1000 also includes one or more remote computing device(s) 1120 and one or more user computing device(s) 1200. Remote computing device(s) 1120 may be, for example, a server computing system that provides cloud-based pest monitoring and notification services for the plurality of establishment(s) 1000A-1000N in accordance with the techniques of the present disclosure. User computing device(s) 1200 may include, for example, computing devices associated with one or more users, such as managers or other employees of establishment(s) 1000A-1000N, service technicians or other employees that provide pest monitoring, notification, and/or remediation services for the establishments 1000A-1000N, or any other user to whom such pest monitoring and notification services may be useful or relevant. User computing device(s) 1200 may include any type of computing device, including mobile computing devices, smart phones, tablet computers, laptop or desktop computers, personal digital assistants, pagers, smart watches, or any other type of computing device.

Pest monitor(s) 1004, local computing device(s) 1008 remote computing device(s) 1120 and user computing device(s) 1200 may communicate using one or more network(s) 1110. Network(s) 1110 may include, for example, one or more of a dial-up connection, a local area network (LAN), a wide area network (WAN), the internet, a wireless or Wi-Fi network, a cell phone network, satellite communication, or any other means of electronic communication. The communication within network(s) 1110 may be wired or wireless.

For example, pest monitor(s) 1004 may be implemented using the pest monitors 100 and/or 200 as shown in FIGS. 1 and 3, respectively. Notification badge(s) 1006 may be implemented using notification badge(s) 140 and/or 240 as shown in FIGS. 1 and 3, respectively. Establishments 1002A-1002N may include any type of establishment or location at which pest monitoring and notification may be desired, and may include, for example, hotels and other lodging establishments; cruise ships; schools; libraries; restaurants; food service or food processing facilities; healthcare facilities such as hospitals, clinics, and nursing homes; apartment buildings; vacation rentals; movie theaters; public transportation; shopping malls; waiting rooms; personal residences and homes; and any other location where detection of insects and/or other pests may be desired.

In use, pest monitor(s) 1004 and notification badge(s) 1006 at each establishment detect and transmit pest detection notifications as shown and described herein with respect to FIGS. 1-7. The notifications may be received by local computing device(s) 1008 and/or may be transmitted to and received by one or more remote computing device(s) 1120. Remote computing device(s) 1120 includes one or more processor(s) 1124 and one or more storage device(s) 1126. Storage device(s) 1126 includes a pest monitor module 1128 including instructions that, when executed by one or more processor(s) 1124, cause processors to analyze, for example, pest presence signals and/or pest event messages received from the pest monitor(s) 1004 associated with each the establishment(s) 1000A-1000N to detect pest presence and/or to generate pest presence notification(s).

In some examples, some of the establishments 1000A-1000N may not include notification badges in their pest detection and notification systems. In such examples, pest monitor(s) 1004 may transmit pest presence signals and/or pest event messages to remote computing device(s) 1120 (and/or they may first be sent to local computing device(s) 1008) and the pest event notification may be generated by remote computing device(s) 1120 and transmitted to one or more of user computing device(s) 1140 and/or local computing device(s) 1008. Such notifications may include, for example, any type of electronic communication such as text messages, emails, banner notification on a mobile device, instant messages, voicemails, or any other manner of sending and receiving electronic communications.

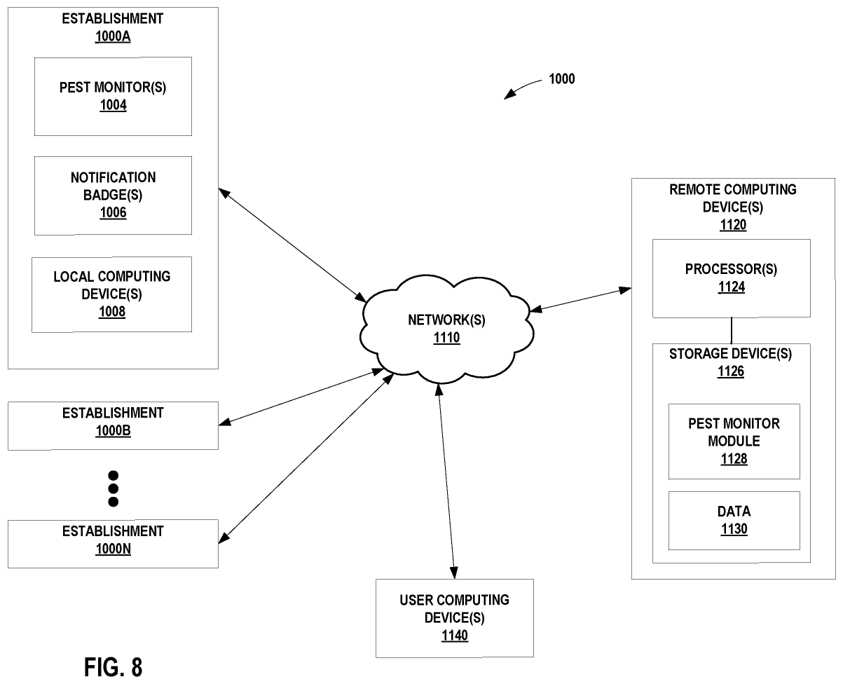

FIG. 9A is a diagram illustrating a top view of another example pest monitor 1200 in accordance with the present disclosure. Pest monitor 1200 includes a printed circuit board 1202, a heater 1204, one or more sensing electrodes 1206, and a textured layer 1208. FIG. 9B is a cross-section of pest monitor 1200 taken from left to right through the area of the sensing electrodes 1206 in FIG. 9A, and showing printed circuit board 1202, sensing electrode layer 1206 disposed on a top surface of the printed circuit board 1202, and textured layer 1208 disposed over at least a portion of sensing electrode layer 1206.

In some examples, pest monitor 1200 may be mounted vertically on a wall or other vertical surface; however, the disclosure is not limited in this respect. Heater 1204 generates heat which attracts a pest 1210 into a housing (not shown in FIG. 9) of monitor 1200. When pest 1210 enters the monitor 1200 they will pass onto and/or over one or more sensing electrodes 1206 disposed on a top surface of circuit board 1202. Presence of a pest 1210 causes a change in the sensed capacitance of electrodes 1206. If the change in sensed capacitance exceeds a predetermined threshold, pest monitor 1200 may determine that a pest is present.

Textured layer 1208 provides a rough or textured surface disposed over at least a portion of printed circuit board 1202 and/or at least a portion of sensing electrodes 1208. Textured layer 1208 includes a rough or textured surface that helps ensure pest interaction with electrodes 1206. Certain insect pests, such as bed bugs, specifically avoid smooth surfaces, and the top surfaces of printed circuit board 1202 and/or electrodes 1206 may be smooth enough that certain pests may avoid crawling onto them when a more preferred rougher surface is available. Textured layer 1208 may increase the likelihood that a pest will crawl onto or otherwise interact with electrodes 1206 such that the pest may be detected. In these examples, textured layer 1208 is also sufficiently thin such that the sensing electrodes are able to detect a threshold change in capacitance when a pest is present.

In some examples, textured layer 1208 includes a mixture of a solder mask and a pumice material that is coated, sprayed, deposited, or otherwise applied over at least a portion of electrode layer 1206 and/or at least a portion of printed circuit board 1202. Solder mask or solder stop mask or solder resist is a thin lacquer-like layer of polymer that is usually applied to the copper traces of a printed circuit board (PCB) for protection against oxidation and to prevent solder bridges from forming between closely spaced solder pads. For purposes of the textured layer 1208, solder mask may be mixed or combined with a pumice material to provide a rough or textured surface on top of at least a portion of electrodes 1206 and/or circuit board 1202 when deposited as textured layer 1208.

When a threshold change in capacitance is detected, a pest presence signal is sent from the pest sensor electronics to the controller (such as controller 202 of FIG. 3). The time and date of the detected pest event may be determined by the controller and stored in memory (such as data 210 of FIG. 3). The controller may then generate and wirelessly transmit a pest event message as described herein with respect to FIG. 4. The wireless message may be transmitted via RF transmitter, IR transmitter, or by other means of wireless transmission. In some examples, the pest event messages may be transmitted upon receipt or may be stored and sent at a later time (e.g., in a batch mode) or upon request of a local or remote computing device.

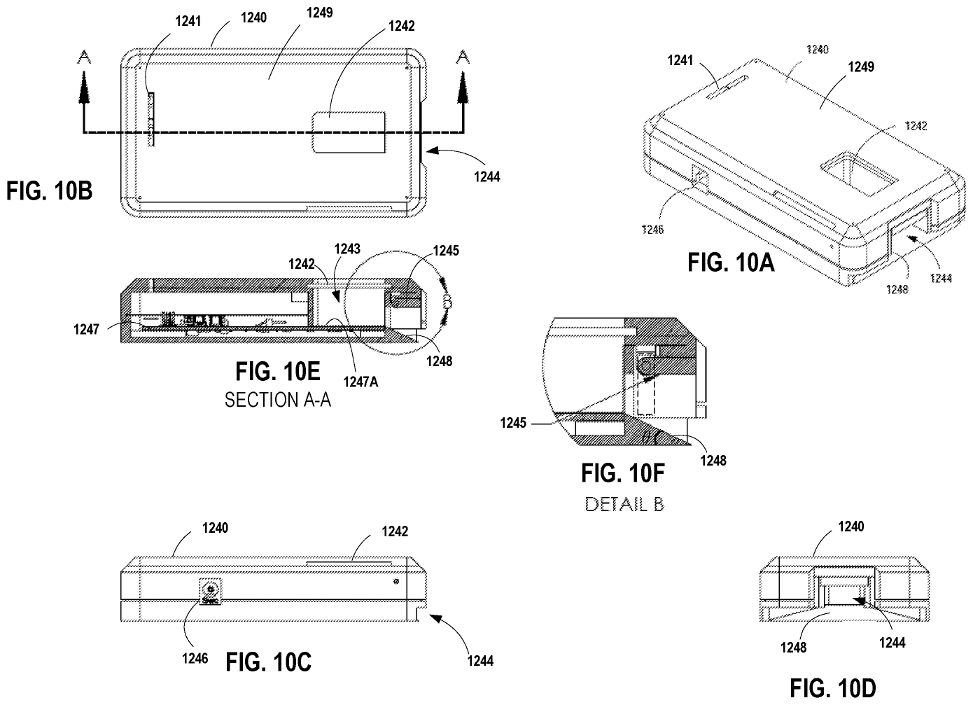

FIGS. 10A-10F are diagrams illustrating various views of an example pest monitor 1240 in accordance with the present disclosure. Pest monitor 1240 includes a housing 1249 forming an interior pest retention chamber 1243. Housing 1249 includes a sight window 1242 that allows a user to see whether a pest has been captured inside chamber 1243 without requiring physical contact. In some examples, sight window 1242 includes a removable clear pane that allows a user to remove a captured pest from chamber 1243. A port 1246 allows power to be received from an AC power adapter. 18.

Housing 1249 includes a back surface and one or more sidewalls. An opening 1244 in one of the sidewalls forms an entrance from outside of housing 1249 into the interior pest retention chamber. A pest enters pest retention chamber 1243 of pest monitor 1240 through entrance 1244 formed in housing 1249. A floor of entrance 1244 forms an entrance ramp 1248. Ramp 1248 forms a path for a pest to travel from entrance 1244 to pest retention chamber 1243.

In some examples, entrance ramp 1248 has a surface texture that allows a pest to grip the ramp and enter the retention chamber without falling off. A circuit board 1247 includes one or more sensing electrodes that form the floor 1247A of chamber 1243. Floor 1247A may also include a textured coating layer having the same or similar surface texture as entrance ramp 1248 such that a pest can crawl across the sensing electrodes on the floor 1247A of chamber 1243. A trap door 1245 at an entrance to chamber 1243 automatically closes when a pest enters the retention chamber 1243 and is sensed by electrodes 1247A. Trap door 1245 may include a foam material around the periphery to create a tight seal when closed to prevent a pest from escaping from retention chamber 1243. Trap door 1245 may manually or electronically controlled between an open position with respect to pest retention chamber 1243, such as shown in FIG. 10F, and a closed position with respect to pest retention chamber 12343, such as indicated by the dashed lines in FIG. 10F. An interior side of trap door 1245 (i.e., the side facing toward the interior of pet retention chamber 1243 when trap door 1245 is closed) may be colored such that it is more easily viewed through sight window 1242 when door 1245 is closed. In this way, if a service technician or other user inspects pest monitor 1240 and sees the colored trap door through sight window 1242, the service technician can visibly determine whether the trap door 1245 has been tripped and therefore that a pest has been retained inside the pest retention chamber 1243. A colored trap door may be more readily viewable by a service technician or other user than a bed bug or other insect captured within the retention chamber 1243 of pest monitor 1240.

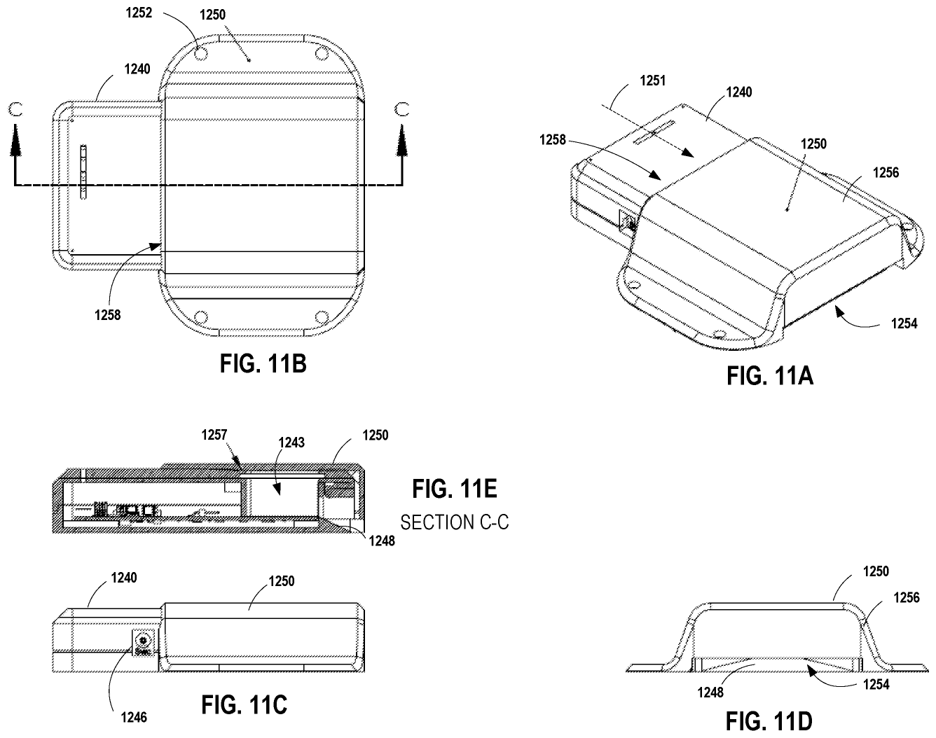

Ramp 1248 forms an angle θ (see FIG. 11F) with the back surface of housing 1249. In some examples, pest monitor 1240 is mounted vertically on a wall or other substantially vertical surface such that the back surface of housing 1249 is against the wall and entry 1244 into housing 1249 and pest retention chamber 1243 faces downward. It has been experimentally determined in accordance with the techniques of the present disclosure that bed bugs and other insect pests can travel over a surface having an angle of less than about 30 degrees to the vertical. In some examples, ramp 1248 is designed such that the angle θ is formed by ramp and the back surface of housing 1249 forms an angle of approximately 25 degrees. approximately a 25 degrees. An angle θ of approximately 25 degrees ensures that bed bugs and other insect pests can travel into entry 1244, up ramp 1248, and onto and over the one or more sensing electrodes on floor 1247A of chamber 1243.

Housing 1249 of pest monitor 1240 may further include a lockout mechanism 1241. Lockout mechanism 1241 allows an authorized user to reset pest monitor 1240 after a pest event has occurred. For example, if a pest has been captured in chamber 1243 and pest monitor 1240 transmits a pest event message which is received by a notification badge and/or a local or remote computing device, a user, such as a service technician, may be called in to service pest monitor 1240. Upon inspection of pest monitor 1240, the service technician or other user may remove the pest from chamber 124. The service technician may further reset pest monitor 1240 by inserting a special key into lockout mechanism 1241. Resetting pest monitor 1240 may cause a pest monitor controller (such as controller 202 as shown in FIG. 3) to stop transmission of the current pest event message(s), open trap door 1245, and be ready to sense another pest event.

FIGS. 11A-11E are diagrams illustrating various views of the example pest monitor 1240 of FIGS. 10A-10F in accordance with the present disclosure mounted in a wall plate 1250. Wall plate 1250 includes a curved wall plate body 1256 and may be mounted to a wall or other substantially vertical surface by any suitable means, such as adhesives or screws (using through-holes, such as through hole 1252). When wall plate is mounted to a wall, for example, curved wall plate body 1256 and the wall form a monitor receiving cavity indicated generally by reference numeral 1258. A pest monitor, such as pest monitor 1240, slides into receiving cavity 1258 in the direction indicated by arrow 1251. Likewise, pest monitor 1240 may be removed from monitor receiving cavity 1258 by sliding in the opposite direction to arrow 1251. The ability to slide a pest monitor 1240 into and out of wall plate 1250 allows a service technician or other user to easily inspect and/or service the pest monitor, such as check whether a pest has been captured in the pest retention cavity 1243, change batteries, reset the device, or otherwise inspect and/or service the device.

In addition, the wall plate body 1256 is comprised of an opaque material such that, when pest monitor 1240 is inserted in cavity 1258, wall plate 1250 covers sight window 1242 of pest monitor 1240, thus reducing the likelihood that any captured insects or other pests will be viewed by a customer or other member of the general public. The interior front surface of wall plate body 1256 includes a ramped surface 1257 configured to press the back surface of pest monitor housing 1249 against the wall when pest monitor 1240 is received into cavity 1258. This reduces any gap between the back surface of pest monitor housing 1249 and the wall, and thus between the entry ramp 1248 and the wall, to help prevent bed bugs and/or other insect pests from crawling behind pest monitor housing 1249 rather than onto ramp 1248.

Wall plate 1250 further includes an opening 1254 on a bottom side of wall plate body 1256 through which bed bugs and/or other insect pests may access ramp 1248 of pest monitor 1240 and thus have access to pest retention chamber 1243 of pest monitor 1240.

The devices described herein are designed for monitoring and/or trapping insect populations such as bed bug, cockroach, ant, flea, termite, beetle, flies, or any other insect population. In addition, the devices, systems and methods described herein may also be used to monitor and alert for presence of other types of pest populations including mice, rats, squirrels, or any other rodent or animal population.

In some examples, the pest monitoring and notification techniques described herein may encompass one or more tangible computer-readable media comprising instructions that cause one or more processors to carry out the methods described above. A “computer-readable medium” includes but is not limited to read-only memory (ROM), random access memory (RAM), non-volatile random access memory (NVRAM), electrically erasable programmable read-only memory (EEPROM), flash memory a magnetic hard drive, a magnetic disk or a magnetic tape, an optical disk or magneto-optic disk, a holographic medium, or the like. The instructions may be implemented as one or more software modules, which may be executed by themselves or in combination with other software.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

The systems and methods may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above.

### EXAMPLES

### Example 1

A pest detection and notification system, comprising a plurality of pest monitors, each of the plurality of pest monitors including at least one pest detection sensor configured to detect presence of a pest within a pest harborage area and generate a corresponding pest presence signal; a controller configured to receive the pest presence signal and generate a pest event message, the pest event message including data indicating presence of a pest; and a wireless transceiver configured to wirelessly transmit the pest event message within a transmission area; and a plurality of notification badges, each notification badge including a wireless receiver configured to wirelessly receive pest event messages transmitted by any one of the plurality of pest monitors when the wireless receiver is located within the transmission area of the wireless transmitter of the any one of the plurality of pest event monitors; at least one pest event indicator; and a controller configured to receive the pest event message and activate the pest event indicator.

### Example 2

The system of Example 1 wherein the at least one pest event indicator includes at least one of an audible indicator, a visible indicator or a vibration motor.

### Example 3

The system of Example 1 wherein the pest event message further includes data indicating a date and time that presence of an insect was detected and a pest monitor id.

### Example 4

The system of Example 3 wherein the pest monitor id includes a serial number that uniquely identifies the pest monitor.

### Example 5

The system of Example 1 wherein the pest event message further includes data indicating a low battery condition of the pest monitor.

### Example 6

The system of Example 1 wherein the controller of each of the plurality of pest monitors is further configured to periodically generate a non-event message if no pest presence signal has been received, and wherein the wireless transceiver of each of the plurality of pest monitors is further configured to wirelessly transmit the non-event message within the transmission area.

### Example 7

The system of Example 1 wherein the transmission area of the wireless transceiver is approximately 5 meters.

### Example 8

The system of Example 1 wherein the pest harborage area includes a guest bed, and wherein the transmission area of the wirelessly transmitter is less than or equal to an area defined by the dimensions of the guest bed.

### Example 9

The system of Example 1 wherein the room in which the pest harborage area includes a hotel room, and in which the transmission area of the pest monitor does not extend into an adjacent hotel room.

### Example 10

The system of Example 1 wherein the insect detection sensor includes a capacitive sensing circuit.

### Example 11

The system of Example 1 wherein the pest monitor further includes a pest trap that contains the pest.

### Example 12

The system of Example 1 wherein the pest monitor includes at least one of a heat attractant, a chemical attractant, a lure, a bait, or a pheromone.

### Example 13

The system of Example 1 wherein at least one of the plurality of pest monitors further comprises a pest trap configured to detect and contain a pest, and further wherein the pest event message includes data indicating that the pest has been trapped.

### Example 14

The system of Example 1, wherein each pest monitor further comprises a printed circuit board; a sensing electrode layer disposed on a top surface of the printed circuit board; and a textured layer disposed over at least a portion of the sensing electrode layer.

### Example 15

The system of Example 14 wherein the textured layer comprises a mixture of a solder mask and a pumice material that is disposed over at least a portion of the sensing electrode layer.

### Example 16

The system of Example 15 wherein the textured layer is coated, sprayed, or deposited over at least a portion of electrode layer.

### Example 17

The system of Example 14 wherein the textured layer provides a rough surface texture for an insect pest to travel on.

### Example 18

The system of Example 1 wherein each pest monitor further comprises a housing including a back surface and one or more sidewalls, the housing forming an interior pest retention chamber and having an opening in one of the sidewalls forming an entrance from outside the housing into the interior pest retention chamber, a floor of the entrance further including a ramp forming a path for a pest to travel from the entrance to the pest retention chamber, the ramp further forming a maximum angle of 30 degrees to the back surface of the housing.

### Example 19

The system of Example 18 wherein the ramp forms an angle of approximately 25 degrees to the back surface of the housing.

### Example 20

The system of Example 18 wherein the ramp has a width that is relatively wider at the entrance as compared to a width of the pest retention chamber.

### Example 21

The system of Example 18 wherein the pest retention chamber further includes an electronically controllable trap door that closes when a pest is detected in the pest retention chamber.

### Example 22

The system of Example 18 wherein the ramp includes a textured surface.

### Example 23

A method, comprising detecting, with a pest monitor, presence of a pest and generating a corresponding pest event message, the pest event message including data indicating presence of a pest; wirelessly transmitting the pest event message within a transmission range corresponding to a pest harborage area; and receiving, with a notification badge present within the transmission area, the pest event message; and activating at least one pest event indicator on the notification badge present within the transmission range upon receipt of the pest event message.

### Example 24

The method of Example 23 wherein activating the at least one pest event indicator includes activating at least one of an audible indicator, a visible indicator or a vibration motor.

### Example 25

The method of Example 23 further comprising deactivating the at least one pest event indicator after a predetermined amount of time has elapsed.

### Example 26

The method of Example 23 wherein the pest event message further includes at least one of a date and time that presence of an insect was detected, a serial number that uniquely identifies the pest monitor, or a low battery condition of the pest monitor.

### Example 27

The method of Example 23 further comprising periodically transmitting a non-event message within the transmission range if no pest presence signal has been received.

### Example 28

The method of Example 23 wherein the transmission range is approximately 5 meters from the pest monitor.

### Example 29

The method of Example 23 further comprising trapping the pest with a pest trap, and wherein the pest event message includes data indicating that the pest has been trapped.

Various examples have been described. These and other examples are within the scope of the following claims.

1. A pest detection and notification system, comprising:
a plurality of pest monitors, each of the plurality of pest monitors disposed in a pest harborage area where at least one pest is likely to be present, including:
at least one pest detection sensor configured to detect presence of a pest and generate a corresponding pest presence signal;
a controller configured to receive the pest presence signal and generate a pest event message, the pest event message including data indicating presence of a pest; and
a wireless transceiver configured to wirelessly transmit the pest event message within a transmission area; and
a plurality of notification badges, each notification badge including:
a wireless receiver configured to wirelessly receive pest event messages transmitted by any one of the plurality of pest monitors when the wireless receiver is located within the transmission area of the wireless transmitter of the any one of the plurality of pest event monitors;
at least one pest event indicator; and
a controller configured to receive the pest event message and activate the pest event indicator.

2. The system of claim 1 wherein the at least one pest event indicator includes at least one of an audible indicator, a visible indicator or a vibration motor.

3. The system of claim 1 wherein the pest event message further includes data indicating a date and time that presence of a pest was detected and a pest monitor id.

4. The system of claim 3 wherein the pest monitor id includes a serial number that uniquely identifies the pest monitor.

5. The system of claim 1 wherein the pest event message further includes data indicating a low battery condition of the pest monitor.

6. The system of claim 1 wherein the controller of each of the plurality of pest monitors is further configured to periodically generate a non-event message if no pest presence signal has been received, and wherein the wireless transceiver of each of the plurality of pest monitors is further configured to wirelessly transmit the non-event message within the transmission area.

7. The system of claim 1 wherein the transmission area of the wireless transceiver is approximately 5 meters.

8. The system of claim 1 wherein the pest harborage area includes a guest bed, and wherein the transmission area of the wirelessly transmitter is less than or equal to an area defined by the dimensions of the guest bed.

9. The system of claim 1 wherein the room in which the pest harborage area includes a hotel room, and in which the transmission area of the pest monitor does not extend into an adjacent hotel room.

10. The system of claim 1 wherein the pest detection sensor includes a capacitive sensing circuit.

11. The system of claim 1 wherein the pest monitor further includes a pest trap that captures or retains the pest.

12. The system of claim 1 wherein the pest monitor includes at least one of a heat attractant, a chemical attractant, a lure, a bait, or a pheromone.

13. The system of claim 1 wherein at least one of the plurality of pest monitors further comprises a pest trap configured to detect and capture a pest, and further wherein the pest event message includes data indicating that the pest has been captured.

14. The system of claim 1, wherein each pest monitor further comprises:
a printed circuit board;
a sensing electrode layer disposed on a top surface of the printed circuit board; and
a textured layer disposed over at least a portion of the sensing electrode layer.

15. The system of claim 14 wherein the textured layer comprises a mixture of a solder mask and a pumice material that is disposed over at least a portion of the sensing electrode layer.

16. The system of claim 15 wherein the textured layer is coated, sprayed, or deposited over at least a portion of electrode layer.

17. The system of claim 14 wherein the textured layer provides a rough surface texture for an insect pest to travel on.

18. The system of claim 1 wherein each pest monitor further comprises:
a housing including a back surface and one or more sidewalls, the housing forming an interior pest retention chamber and having an opening in one of the sidewalls forming an entrance from outside the housing into the interior pest retention chamber,
a floor of the entrance further including a ramp forming a path for a pest to travel from the entrance to the pest retention chamber,
the ramp further forming a maximum angle of 30 degrees to the back surface of the housing.

19. The system of claim 18 wherein the ramp forms an angle of approximately 25 degrees to the back surface of the housing.

20. The system of claim 18 wherein the ramp has a width that is relatively wider at the entrance as compared to a width of the pest retention chamber.

21. The system of claim 18 wherein the pest retention chamber further includes an electronically controllable trap door that closes when a pest is detected in the pest retention chamber.

22. The system of claim 18 wherein the ramp includes a textured surface.

23. A method, comprising:
detecting, with a pest monitor, presence of a pest and generating a corresponding pest event message, the pest event message including data indicating presence of a pest;
wirelessly transmitting the pest event message within a transmission range corresponding to a pest harborage area; and
receiving, with a notification badge present within the transmission area, the pest event message; and
activating at least one pest event indicator on the notification badge present within the transmission range upon receipt of the pest event message.

24. The method of claim 23 wherein activating the at least one pest event indicator includes activating at least one of an audible indicator, a visible indicator or a vibration motor.

25. The method of claim 23 further comprising deactivating the at least one pest event indicator after a predetermined amount of time has elapsed.

26. The method of claim 23 wherein the pest event message further includes at least one of a date and time that presence of an insect was detected, a serial number that uniquely identifies the pest monitor, or a low battery condition of the pest monitor.

27. The method of claim 23 further comprising periodically transmitting a non-event message within the transmission range if no pest presence signal has been received.

28. The method of claim 23 wherein the transmission range is approximately 5 meters from the pest monitor.

29. The method of claim 23 further comprising capturing the pest with a pest trap, and wherein the pest event message includes data indicating that the pest has been captured.
